(19) United States
(12) Patent Application Publication
(10) Pub. No.: US 2018/0151280 A1
(43) Pub. Date: May 31, 2018

(54) PRE-COOLING AND INCREASING THERMAL HEAT CAPACITY OF CRYOGEN-FREE MAGNETS

(71) Applicant: Shahin Pourrahimi, Brookline, MA (US)

(72) Inventor: Shahin Pourrahimi, Brookline, MA (US)

(21) Appl. No.: 15/361,245

(22) Filed: Nov. 25, 2016

(51) Int. Cl. H01F 6/04; H01F 6/06

(52) U.S. Cl. CPC H01F 6/04; H01F 6/06

(57) ABSTRACT

Methods, systems, and articles of manufacture are disclosed for reducing the cool down time of a superconducting magnet and increasing the heat capacity of its cold-mass within an actively or passively shielded, Cryogen-Free (CF), conduction-cooled superconducting magnet. In these methods, while cooling substances are circulated by a network of tubes around the radiation shield and the cold-mass of the magnet system to speed up the cooling process of the system, at least a part of the cooling substance or another substance is left and sealed within the tubing network to increase the heat capacity of the system and to prevent rapid rise of temperature in cases such as an occasional/accidental system shutdown.

### CROSS-REFERENCE(S) TO RELATED APPLICATION(S)

This application claims the benefit of the filing date of the U.S. Provisional Patent Application 62/259,740, entitled “Pre-cooling and Increasing Thermal Heat Capacity of Cryogen-free Magnets,” filed on Nov. 25, 2015, under 35 U.S.C. § 119(e), and is hereby included in its entirety by reference.

### TECHNICAL FIELD

This application relates generally to superconducting magnets. More specifically, this application relates to a method and apparatus for reducing the cool down time of a cryogen-free superconducting magnet and increasing the heat capacity of its cold-mass.

### BRIEF DESCRIPTION OF THE DRAWINGS

The drawings, when considered in connection with the following description, are presented for the purpose of facilitating an understanding of the subject matter sought to be protected.

FIG. 1 shows an example arrangement for using a conventional whole-body Magnetic Resonance Imaging (MRI) system for medical diagnostics;

FIG. 2 shows a schematic diagram of a conventional superconducting magnet;

FIG. 3 shows a schematic diagram of a conventional conduction cooled (Cryogen-Free) superconducting magnet; and

FIG. 4 shows a schematic diagram of an example conduction cooled (Cryogen-Free) superconducting magnet equipped with additional subsystems to expedite the cool down time of the cryogen-free magnet system and to increase the heat capacity of the system to slow down and reduce the rise in temperature in case of an occasional higher heat input condition like cryocooler system shutdown.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while the following description references application of specific gases and liquids and sample piping/tubing for distribution of coolants, it will be appreciated that the disclosure may apply to other gases and liquids and other arrangements for distribution of cooling agents.

Briefly described, methods, systems, and articles of manufacture are disclosed for reducing the cool down time of a superconducting magnet and increasing the heat capacity of its cold-mass within an actively or passively shielded, conduction-cooled (also known as Cryogen-free) superconducting magnet. There are various applications for superconducting magnets including those in medical, energy, transportation, and scientific research. The superconducting magnets of the Magnetic Resonance Imaging (MRI) systems discussed in this disclosure, are merely examples of such magnets. In the following various embodiments, methods and apparatus for additional heat extraction from the conduction cooled MRI systems are disclosed that also increase the thermal heat capacity of these systems.

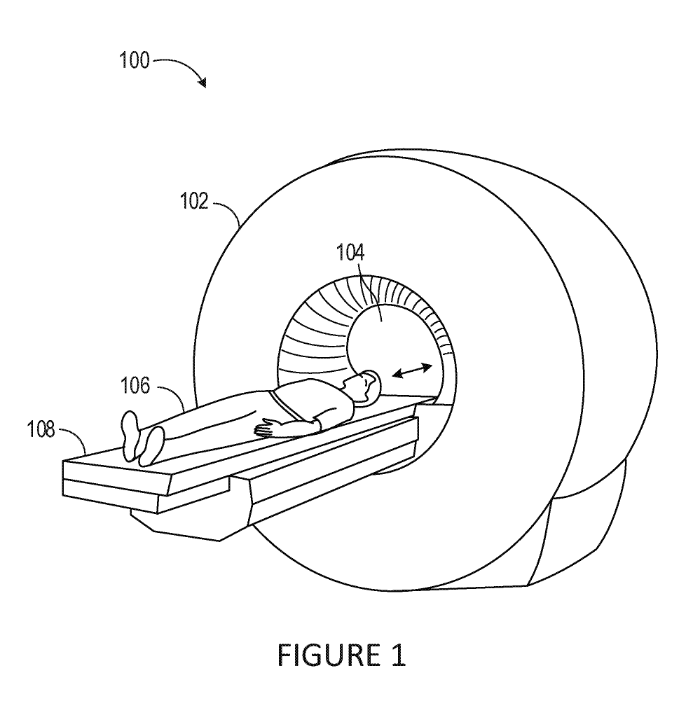

MRI is a technique for accurate and high-resolution visualization of interior of human and animal tissues. This technique is based on the nuclear magnetic resonance (NMR) property. MRI is often implemented in the form of a scanning device or scanner in which the patient lies horizontally within a scanning bore (see FIG. 1) of sufficient size to accommodate the whole body of the patient. The scanning bore is surrounded by various devices including a magnet generating a powerful static magnetic field that surrounds the patient lying within the scanning bore. The static magnetic field aligns the magnetic dipole moment of protons in atomic nuclei in the patient's tissues in the direction of the magnetic field of the magnet. Then, magnetic field gradients and Radio Frequency (RF) magnetic fields are applied to encode the protons, and generate and receive electromagnetic signals. Open MRI machines are also used for some applications in which patient is situated between two magnetic components, usually on top and bottom with open sides, instead of a cylindrical bore completely enclosing a section of the patient's body on all sides.

FIG. 1 shows an example arrangement for using a Magnetic Resonance Imaging (MRI) system for medical diagnostics. Typically, a diagnostic arrangement 100 includes a whole-body MRI scanner 102 having a scanning bore 104, which is a tunnel-like opening, to accommodate the whole body of a patient 106 lying on a bed 108. The bed 108 slides into the opening 104 to position the appropriate portion of the patient's body within the MRI magnet system to start the scanning process.

Imaging by an MRI scanner requires a very uniform, constant, and stable magnetic field over a specific volume. Conventionally, such a magnetic field, often referred to as a Bo field, is produced by a permanent or superconducting magnet. For human applications, MRI devices that use permanent magnets typically generate Bo magnetic fields of less than 0.5T, and for research on animals, they generate less than 1.5T. For higher resolution imaging, superconducting magnets producing higher magnetic fields are used.

MRI, in part, utilizes the fact that body tissue contains a large proportion of water, and the fact that different tissues have different water contents and can be distinguished from one another. Each water molecule has two hydrogen atoms, and the nucleus of each atom has a signal spinning proton that has a positive charge. Each spinning proton has a magnetic dipole moment and is like a very small magnet that can interact with the field of other magnets. Each proton not only spins, but also precesses around its dipole directions. In ordinary condition the magnetic dipole moment direction of the protons are randomly oriented. However, when placed inside the static magnetic field of an external magnet the magnetic dipole of the protons within the body aligns with the magnetic field of the magnet and their precession frequency increases proportional to the external magnetic field.

To obtain information about the location of and concentration of hydrogen protons within specific tissue, a specific tissue/organ is placed within a highly homogeneous and uniform static field of an external magnet. Gradient coils are used to produce a momentary RF current to generate a varying electromagnetic field with a resonance frequency, which changes or flips the spin of the protons. After the gradient coils are turned off, the gradient varying magnetic field disappears causing the spins of the protons to return to their original states and be re-aligned with the static magnetic field. This return to original spin state is called “relaxation.” During this relaxation, an RF signal is generated by the change in the spin, which can be measured by instruments such as receiver coils. Thus, 3D information about the origin of the signal in the body may be obtained by applying additional gradient magnetic fields. These additional gradient magnetic fields may be applied to generate signals only from specific locations in the body (spatial excitation) and/or to make magnetization at different spatial locations precess at different frequencies, which allows k-space (k-space is the 2D or 3D Fourier transform of the MR image) encoding of spatial information. The 3D images obtained in MRI can be rotated along arbitrary orientations and manipulated by the medical professional to detect changes of structures within the body.

Protons in different tissues return to their original equilibrium state within the static magnetic field at different relaxation rates. Different tissue variables, including spin density, various relaxation times, and flow and spectral shifts, can be used to construct images. By changing the settings on the scanner, contrast may be created between different types of body tissue. MRI may provide better contrast between the different soft tissues of the body, such as the organs, the brain, muscles, the heart, malignant tissues, and other soft tissues compared with other imaging techniques such as Computer Tomography (CT) or X-rays. MRI is also generally safer because unlike CT scan or X-ray, no ionizing radiation is used in MRI, and thus, it is safer from a radiation standpoint. As such, MRI scanners are often used for biomedical research and diagnosis of human disease and disorder.

In common MRI scanner the external highly homogeneous and uniform static field is between 0.2 T to 3 T. Having the proton uniformly aligned is not enough to gain knowledge about the location and concentration of the protons in specific regions of the tissue. To encode the spatial location of the protons a set of so called gradient coils are used to change the local magnetic field intensity around protons of the tissue. The set of gradient coils are charged in specific sequences and frequencies to superimpose certain linearly varying magnetic fields in X, Y, and Z direction over the static magnetic field. The gradient coils can change the field intensity and alignment of the highly homogeneous and uniform static field by, for example, 50 mT/m in the direction of the specific gradient coil being charged. Therefore, if the external highly homogeneous and uniform static field is produced over a spherical volume of 0.5 m in the diameter, then the local field, and the corresponding precession frequency of the protons, at one end of the sphere is 25 mT higher than the other end, and information is obtained about where the protons are located because the field intensity and orientations are different at different locations.

X, Y, and Z gradient coils are used to obtain information about proton locations three dimensionally. To produce signals from protons one or more additional coils are used to transmit and receive radio frequency electromagnetic waves pulses. The reason the additional coils pulse at radio frequency (RF) is that proton precession in external field of a fraction of a tesla to a few tesla are in RF range. When an RF coil transmits a magnetic pulse (wave) the precession of the protons are disturbed accordingly. When the transmitted pulse ends the proton dipole directions and precessions tend to return to the original orientation. The return of the dipole direction and precession of the protons produce RF signals that are received by one and the same, or different, receiving coils. The more the number of RF transmit and RF receive coils the more information about the local hydrogen protons.

The MRI image is subsequently constructed with electronic devices and computer software that process and interpret the detected RF signals. The magnetic field gradients thus applied cause nuclei in various tissues and locations within the body to precess (change in the orientation of the rotational axis of a rotating body) at different rates or speeds. The different precession rates allow spatial information needed to construct an image to be recovered from the measured signals using various mathematical techniques, such as Fourier analysis. By using gradient fields in different directions, two Dimensional (2D) images or 3D volumes can be obtained in any arbitrary orientation.

Superconducting Bo magnets use coils that need to be maintained at cryogenic temperatures that are lower than the critical temperature of the superconducting coils to allow superconductor mode of the coil material to appear, in which electrical resistance is zero. To achieve this, conventionally, the coils of a superconducting MRI magnet operate in a pool of liquid helium, at close to atmospheric pressure that keeps the coils at about 4.2 K.

An alternative to operating MRI superconducting coils in a pool of liquid helium is to cool down the coils by the second stage of the two-stage cryocooler that is connected to the coils by solid materials that conduct heat away from the magnet system. Conventionally, these types of magnets are called “cryogen-free” (CF) or conduction cooled magnets. In a CF magnet, the two-stage cryocooler—also known as a cryo-refrigerator—makes physical contact with designated parts of the magnet system thereby extracting heat by way of conduction through the connected parts. The amount of cooling (removal of heat) that is provided by a two stage cryocooler can be a few tens of watts for the first stage, achieving, for example, a temperature of 30-60K, and a few watts for the second stage, achieving 3-20K. The first stage of the cryocooler makes contact to the radiation shield and certain other parts, and the second stage to the cold-mass. Cold-mass includes the superconducting coils, and the structure that keeps the assembly of coils together, and certain other electrical components that need to be at 3-20 K.

Heat transfer to a superconducting magnet is by way of convection, radiation and conduction. In the case of a cryogen-free superconducting magnet, convection heat transfer is reduced by housing the superconducting magnet inside a vacuum chamber (vessel), which in this case is referred to as the “cryostat.” Radiation heat transfer may be reduced by housing the superconducting magnet inside a radiation shield, which in turn may be housed within the vacuum chamber. This radiation shield is cooled by the first stage of the two-stage cryocooler to a temperature of 30-60K, and is generally covered on the side facing the vacuum chamber with several layers of reflective insulation, often referred as “super-insulation.” Conduction heat transfer may also be reduced by proper material selection and strategic placement of such low-heat conductivity material.

A consideration regarding a cold-mass is that because it operates at a temperature of less than 20K, its heat capacity is relatively low and in cases where there is an interruption in cooling by the cryocooler, or when superconducting coils produce heat by so called AC losses, the cold-mass temperature rises relatively fast.

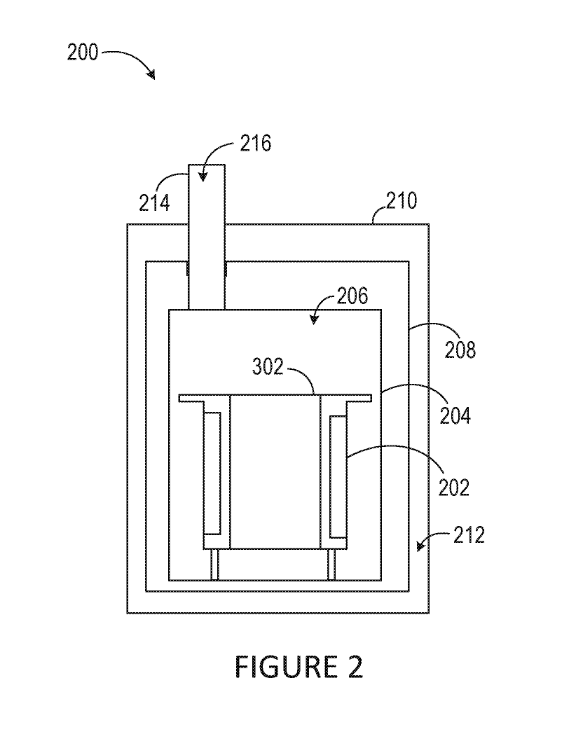

FIG. 2 shows a schematic diagram of an example cryogen-free superconducting magnet 200 and its major parts. As illustrated in FIG. 2, the superconducting coil 202, which is the main part of the cold-mass, is completely enclosed within the helium vessel 204, which is filled with helium 206. The helium vessel 204 itself is enclosed within and surrounded by the radiation shield 208 to minimize the radiation heat transfer to the cold-mass and, in turn, the radiation shield 208 is placed inside the vacuum space 212 within the exterior vessel 210 to prevent conductive heat transfer between the radiation shield 208 and the exterior vessel 210. The helium vessel 204 is supplied with liquid helium 216 through the helium pipe or conduit 214, which passes through both the exterior vessel 210 and the radiation shield 208 to reach the helium vessel 204.

For safety reasons, MRI scanners are used and operated within an area where the magnetic field outside of the area is less than 5 Gauss. The area inside of the 5 Gauss line is sometimes called the MRI magnet's 5-Gauss footprint. For reasons of efficiency and installation cost, superconducting magnets used in MRI applications are magnetically shielded to minimize the 5-Gauss footprint. MRI superconducting magnets may be shielded actively or passively. Actively shielded MRI superconducting magnets are often comprised of main field coils that generate the uniform static magnetic field of higher than 1 T in the area of the geometric center of the magnet systems. Another one or more shielding coils are deployed on the outside of and enclosing or surrounding the field coils to reduce the magnetic footprint of the overall magnetic system by reducing the distance from the core of the machine at which the magnetic field drops to 5 Gauss or less. The sense or direction of the electrical current in the shielding coils is opposite to the sense of the current in the field coils to induce a magnetic field that reduces or cancels the magnetic field created by the static field outside the MRI scanner.

Passively shielded MRI magnets have a set of superconducting main coils and ferromagnetic materials placed strategically on the outside of the superconducting magnet to reduce external magnetic field. In various embodiments, shielding of an MRI magnet may be provided by a combination of active coils and passive ferromagnetic materials. It is noteworthy to recognize that whether an MRI magnet is shielded actively or passively, there is radial space between the field coils and the shielding coils or the ferromagnetic shields. Often, in actively shielded MRI superconducting magnets, the field coils and shield coils are placed in the same cryogenic vessel (cryostat). While there is radial space between the field coils and the shield coils, magnet designers tend to minimize the radial space so the overall diameter of the cryostat is minimized. The higher the desired magnetic field in the scanning bore of the MRI, the larger the magnet is.

All parts of superconducting magnets including the radiation shield and those that will eventually constitute the cold-mass are built or assembled essentially at room temperature. In a cryogen-free magnet the radiation shield of the system is cooled from room temperature to its target temperature by the first stage of the cryocooler, and the cold-mass from room temperature to its target temperature by the second stage of the cryocooler. The period of time required for the magnet system to reach its target temperatures for its various stages is called “cool-down period.” Depending on the size of the magnet system the cool down time may be a few hours, a few days, or a few weeks. It is always desirable to cool down the system as quickly as possible. Additionally, in traditional systems, because the heat capacity of the cold-mass is relatively low, during higher heat input occasions like when a planned or accidental interruption occurs in cooling process of the cryocooler, or if the superconducting coils produce heat by so called AC losses, the cold-mass temperature rises relatively fast.

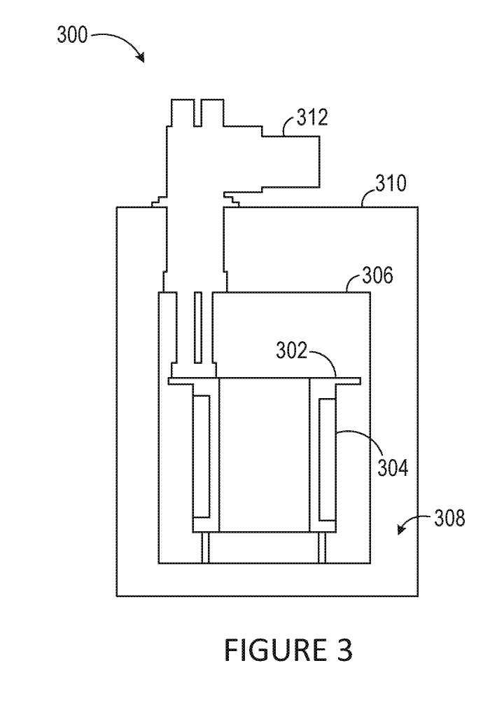

FIG. 3 shows a schematic diagram of a conventional conduction cooled (Cryogen-Free) superconducting magnet 300. As illustrated in this figure the cold-mass 302, which includes superconducting coil 304, is again within the radiation shield 306, which itself is situated within the vacuumed space 308 of an exterior vessel 310. As shown in FIG. 3 and described in detail above, a two-stage cryocooler 312 transfers the heat from the cold-mass 302 and the radiation shield 306 to the outside of the superconducting magnet 300.

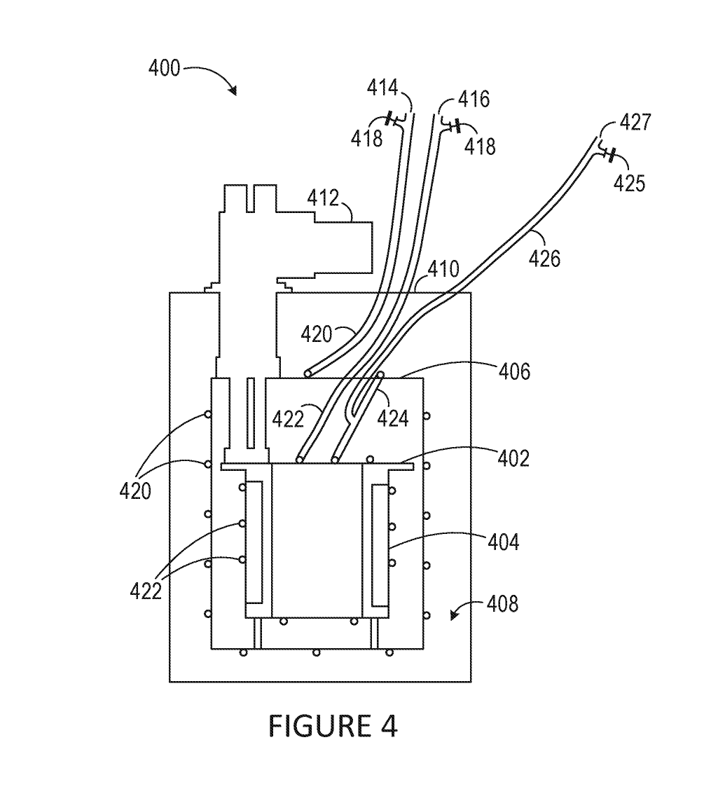

According to the present disclosure, to expedite the cool down time of a cryogen-free magnet system, the magnet system may employ additional subsystems or components to cool the radiation shield and the cold-mass parts by cold gases and/or liquids, such as by cold nitrogen gas and liquid nitrogen. FIG. 4 schematically illustrates a cryogen-free magnet system 400, which is similar to the magnet system 300 of FIG. 3 but is further equipped with the mentioned additional subsystems. In this example embodiment, while valve 425 is closed, a preferred cryogen 414 enters the exterior vessel 410 via tubing 420 which is wrapped around the radiation shield 406. After circling radiation shield 406, the cryogen enters the volume within the radiation shield 406 via the connecting tube 424 and circles around the cold-mass 402 via the tubing part 422 that is traced around cold-mass 402. Subsequently, after exiting the radiation shield 406 and the exterior vessel 410, the cryogen 416 leaves the system through the last portion of tubing part 422. It should be noted that the word “valve” in this specification is the representative and an example of any method or mechanism by which the tubing parts can be closed.

After cooling down different parts of the magnet system 400 to desired temperatures, at least a part of cryogen 414 is retained and sealed in the tubing parts 420, 422, and 424 by closing valves 418. Retaining cryogen 414 in the tubing network increases the heat capacity of the magnet system 400, in particular the heat capacity of the cold-mass 402 and the radiation shield 406. The merit of leaving a certain mass of helium inside a sealed container inside the cold-mass of a superconducting magnet is discussed by Pourrahimi in U.S. Pat No. 6,622,494. The rate of temperature rise of the magnet system 400, in case of an accidental shutdown, may be controlled by the amount and the type of the cryogen that is sealed within the tubing network of the magnet system 400.

In the embodiment shown in FIG. 4, after cryogen 414 is circulated around radiation shield 406 and cold-mass 402, tubing part 426 provides an additional option to continue circulating the cryogen around the cold-mass 402 alone. If such continuous cooling of the cold-mass 402 is desired, the valve 418 on tubing part 420 will be kept closed and the valve 418 on tubing part 422 and the valve 425 on tubing part 426 will be kept open for circulating the same or a different cooling agent around the cold-mass 402.

Various embodiments may be very similar to the one shown in FIG. 4, but may not have the tubing part 426 and its valve 425.

In some embodiments at least some parts of the mentioned tubing circuit that are in contact with different parts of the magnet system, such as with the cold-mass 402 and the radiation shield 406, are made of particular materials with low heat conductivity to minimize, for example, the conductive heat transfer between these parts. In other embodiments more than one kind of cooling agents and/or other gaseous or liquid substances may be passed through or retained in the tubing circuit. In most embodiments the volume inside the tubing network is completely isolated from the volume within the exterior vessel 410 and the volume within the radiation shield 406. In other words, the inside of the tubing is entirely isolated from its outside for the entire length of the tubing that is enclosed within the exterior vessel 410.

In various embodiments, which do not include the tubing part 426 and its valve 425, a first cryogen tube may enter the exterior vessel 410, encircle the radiation shield 406 and exit the exterior vessel 410 and a separate second cryogen tube may enter the exterior vessel 410 and radiation shield 406, trace around the cold-mass 402 and exit both the radiation shield 406 and the exterior vessel 410. In some embodiments the two separate tubing circuits may carry different cryogens. In such embodiments one has also the option of continuing to cool the cold-mass 402 while the circulation of the cryogen around the radiation shield has stopped.

In yet other embodiments a cryogen tube may enter the exterior vessel 410, encircle the radiation shield 406 and exit the exterior vessel 410 only to enter a cooling component, to cool down the exiting cryogen before reentering the system to extract additional heat from the cold-mass 402 and to subsequently exit the system 400. In various embodiments the tubing may be metallic or non-metallic. Since the change in the temperature affects the pressure of the substance left in the tubing network(s), in some embodiments the pressure at which the tubes are sealed is predetermined and pre-calculated and in other embodiments the tubing network(s) may have pressure valves or pressure regulators to prevent damage to the tubing and to the system in case of a rise in pressure(s). In general the two tubing networks that cool the radiation shield 406 and the cold-mass 402 may be in parallel in some embodiments or in series in others.

As an example of the disclosed method, at first nitrogen may be pumped through the tubing network. In some embodiments the pumped nitrogen may be in the form of gas followed by liquid nitrogen. Depending on the application, after the nitrogen cold hydrogen may be pumped in the tubing. Again in some embodiments the hydrogen may first be in the form of gas followed by liquid hydrogen. In yet other embodiments of the application, the hydrogen may also be followed by cold helium which itself may be in gaseous form before liquid helium is pumped through the tubes. At the desired achieved temperature of the cold-mass and/or the radiation shield, a preferred amount of the last cooling substance/element is left inside the tubing network and is sealed within the tubing. In various embodiments the last substance pumped into and left in the tubing may be any of the previously pumped cooling agents or a different substance.

The flow of nitrogen, for example, can allow cooling the radiation shield and the cold-mass of a magnet system to 77 K or even 67 K much faster than it is possible by the two stage cryocooler. The subsequent flow of hydrogen allows cooling the cold-mass of a magnet system to about 20 K, faster than possible by the 2nd stage of a cryocooler. And the final flow of helium can cool the cold-mass of a magnet system to less than 10 K or even close to 4 K; faster than possible by the 2nd stage of a cryocooler.

It must be noted that in various embodiments different tubing arrangements, such as series or parallel, different combination and permutation of procession of cooling substances and different cooling agents in different phases or states, such as gas or liquid, may be employed without departing from the spirit and scope of the invention.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Also, in this specification and claim set, the phrase “A and/or B” will be understood to include the possibilities of “A” or “B” or “A and B.”

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

1. A method of speeding up the cooling process of an actively or passively shielded, or not shielded, Cryogen-Free (CF), and conduction-cooled superconducting magnet while increasing a heat capacity of the superconducting magnet to slow down and/or reduce a temperature rise in case of occasional higher heat input to the radiation shield and/or the cold-mass of the superconducting magnet, wherein the superconducting magnet is comprised of an exterior vessel enclosing a radiation shield within which a cold-mass is placed and a two-stage cryocooler that is attached to the radiation shield and the cold-mass, and a tube that enters the superconducting magnet traces the radiation shield or the cold-mass or both and leaves the superconducting magnet, the method comprising:
circulating at least a cooling agent around the radiation shield or around the cold-mass or around both, by injecting the cooling agent into the tube, to bring down a temperature of the radiation shield or the cold-mass or both to desired temperatures; and
leaving at least a portion of the cooling agent in the tube or part of the tube.

2. The method of claim 1, wherein nitrogen or hydrogen or helium or any combination and/or permutation thereof are consecutively circulated around the radiation shield or around the cold-mass or around both.

3. The method of claim 2, wherein the cooling agent left in the tube is sealed within the tube.

4. The method of claim 1, wherein the sealed cooling agent is left in the tube at a predetermined pressure to ensure a desired mass of agent remains in the tube as pressure changes during changes of temperature.

5. The method of claim 1, wherein at least the tube portions between the cold-mass and the radiation shield and between the radiation shield and the exterior vessel are made of predetermined metal or metal alloys that reduce the heat transfer between the cold-mass and the radiations shield and the radiation shield and the exterior vessel.

6. The method of claim 1, wherein sealing is accomplished by valves at both ends of the tube, outside the superconducting magnet.

7. The method of claim 1, wherein the portion of the cooling agent left and sealed in the tube is predetermined to reduce a rate of the temperature rise in case of an occasional higher heat input to magnet system.

8. The method of claim 1, wherein a first cryogen tube enters the exterior vessel and encircles the radiation shield and exits the exterior vessel and a separate second cryogen tube enters the exterior vessel and the radiation shield and traces the cold-mass and exits both the radiation shield and the exterior vessel and wherein the radiation shield and the cold-mass may be cooled separately by same or different cooling agents and for same or different length of time.

9. The method of claim 1, wherein a first cryogen tube enters the exterior vessel and encircles the radiation shield and subsequently enters the radiation shield vessel and traces the cold-mass and exits both the radiation shield and the exterior vessel and wherein a second tube branches off the first tube within the radiation shield and before encircling the cold-mass and subsequently exits both the radiation shield and the exterior vessel and wherein the radiation shield and the cold-mass may be cooled together or separately by same or different cooling agents and for same or different length of time.

10. The method of claim 1, wherein the cold-mass includes a superconducting coil.

11. A method of accelerating the cooling process of a Cryogen-Free (CF), and conduction-cooled superconducting magnet and decelerating a temperature rise of the magnet in case of an occasional higher heat input to the magnet system, the method comprising:
wrapping at least a first conduit around a radiation shield of the superconducting magnet;
wrapping at least a second conduit around a cold-mass of the superconducting magnet;
inserting a first cooling substance inside the first conduit;
inserting a second cooling substance inside the second conduit; and
leaving at least a part of the first and/or the second cooling substance in the conduits after desired temperatures of the radiation shield and the cold-mass are reached.

12. The method of claim 11, wherein nitrogen, hydrogen, and helium are consecutively circulated around the radiation shield or around the cold-mass or around both.

13. The method of claim 11, wherein the cooling substance in the conduits is sealed within the conduits.

14. The method of claim 11, wherein the sealed cooling substance is left in the conduit at a predetermined pressure to ensure a desired mass of agent remains in the tube as pressure changes during changes of temperature.

15. The method of claim 11, wherein the second conduit is an extension of the first conduit and the conduit portions between the cold-mass and the radiation shield and between the radiation shield and the exterior vessel are made of predetermined metal or metal alloys that reduce the heat transfer between the cold-massed and the radiations shield and the radiation shield and the exterior vessel.

16. The method of claim 11, wherein an output of the first conduit is an input to a subcomponent that processes cooling substances and an input of the second conduit is an output of said subcomponent and wherein the subcomponent resides outside the superconducting magnet.

17. A Crygen-Free (CF), and conduction-cooled superconducting magnet system comprising:
a cold-mass that includes a superconducting coil;
a radiation shield that encloses the cold-mass and reduces radiation heat transfer to the cold-mass;
an exterior vessel enclosing the radiation shield, wherein a space between the exterior vessel and the radiation shield and radiation shield and cold-mass is vacuumed to reduce conduction and/or convection heat transfer from the exterior vessel to the radiation shield and radiation shield to cold-mass;
at least one conduit which has an input end and an output end and which is wrapped around the radiation shield or around the cold-mass or around both, wherein the input end and the output end are situated outside the exterior vessel, and wherein the conduit is used to hold or circulate cooling or other desired substances around the radiation shield and/or around the cold-mass; and
at least one valve to close the input end and the output end of the conduit to seal any substances within the conduit at any desired pressure to add to a heat capacity of the system to control a rise in temperature of the superconducting coil in case of any occasional higher heat input to magnet system.

18. The system of claim 17, wherein the superconducting magnet system is an actively or passively shielded, Cryogen-Free (CF), and conduction-cooled system.

19. The system of claim 17, wherein at least a first conduit, which has a first input end and a first output end, is wrapped around the radiation shield and a second conduit, which has a second input end and a second output end, is wrapped around the cold-mass and where the first and the second input and output ends are located outside the exterior vessel.

20. The system of claim 19, wherein any substance within the first or the second conduit is sealed separately by separate valves under any desired pressure.
